(19) United States
(12) Patent Application Publication
(10) Pub. No.: US 2020/0051198 A1
(43) Pub. Date: Feb. 13, 2020

(54) ON-DEMAND BASED PRICING CAPABILITIES FOR PARKING MANAGEMENT

(71) Applicant: FlashParking, Inc., Austin, TX (US)

(72) Inventors: Juan Fabian Rodriguez, Austin, TX (US); Dean Alan Cleaver, Austin, TX (US); Eliseo Joaquin Diaz, Austin, TX (US); Carlos Hernandez, Austin, TX (US); Martin Greg Ward, Austin, TX (US)

(73) Assignee: FlashParking, Inc., Austin, TX (US)

(21) Appl. No.: 16/536,065

(22) Filed: Aug. 8, 2019

Related U.S. Application Data
(60) Provisional application No. 62/716,255, filed on Aug. 8, 2018.

(51) Int. Cl. G06Q 50/30; G06Q 30/02

(52) U.S. Cl. CPC G06Q 50/30; G06Q 30/0283

(57) ABSTRACT

A real-time parking management method and system are disclosed. The fee for access to a parking facility varies based on the capacity of the parking facility. Alternatively, the fee may vary based on the size, weight or capacity of the vehicle. Still alternatively, the fee may vary based on the specific weather conditions at the time the vehicle enters the parking facility. In certain instances, a parking facility may auction parking spaces and award the space to the highest bidder.

### PRIORITY STATEMENT UNDER 35 U.S.C. § 119 & 37 C.F.R. § 1.78

This non-provisional application claims priority based upon prior U.S. Provisional Patent Application Ser. No. 62/716,255 filed Aug. 8, 2018 in the names of Juan Fabian Rodriguez, Dean Alan Cleaver, Eliseo Joaquin Diaz, Carlos Hernandez, and Martin Greg Ward entitled “ON-DEMAND BASED PRICING CAPABILITIES FOR PARKING MANAGEMENT” the disclosures of which are incorporated herein in their entirety by reference as if fully set forth herein.

### BACKGROUND OF THE INVENTION

Currently, parking facility operators do not have the ability to automatically price their parking facilities in accordance with changing demand based on data-driven decisions, so the process of configuring pricing must be done manually. Current methods known in the art for modifying parking rates require the operator to manually go to a parking terminal to make the desired changes.

There is a need, therefore, for a method and system that allows rates to be determined ahead of time based on a known set of variables and then pre-programmed for automatic execution in the future when the variable conditions are present. Such a system would allow the parking facility operators to set pricing rates in advance based on variables relevant to consumer demand, such as the consumer vehicle's unique specifications (e.g. occupancy capacity), date/time of arrival, nearby event conditions, weather conditions, and more.

### SUMMARY OF THE INVENTION

Embodiments of the present invention relate generally to the methods and systems for parking garage, surface lot, valet, and contract parker management. More specifically, those embodiments relate to dynamically offering demand-based parking rates based on pre-selected variables, such as parker type, vehicle details, date, time, parking facility occupancy, nearby events, and weather conditions.

The on-demand based pricing solution of the present invention allows parking facility operators to capture and determine multiple parking variables, present data-driven parking rates, and gain revenue based upon parking demand conditions. The integrated software, hardware, and process-based system can differentiate parker types, such as contract, monthly, resident, overnight, online-prepaid, and transient parkers, and fluctuate the price for those parkers based on occupancy capacity, time of date, neighboring events, event conditions, weather (e.g. rain or snow), etc. In addition, as the system continues to gather data, it will process and store the data to analyze trends based on past events. For example, as the system gathers transactional information for a parking facility, the analysis of that information will allow the system to understand patterns within a given set of events (occupancy, weather, local events, etc.) and use that information to, for example, determine the price to maximize the revenue to the facility. This artificial intelligence functionality will continue to provide additional value as the amount of information gathered by the system grows.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention.

### DESCRIPTION OF THE DRAWINGS

For a more complete understanding of the present invention, and the advantages thereof, reference is now made to the following descriptions taken in conjunction with the accompanying drawings, in which:

FIG. 1 shows a standard physical sign known in the art which is not dynamic and is costly to replace each time the rates changes; and

FIGS. 2A and 2B show two different digital displays located at a parking facility utilizing an embodiment of the present invention, each of which communicates the current parking price to parkers and is updated automatically as the price changes;

FIG. 3 shows a screenshot of a digital display at a parking facility utilizing an embodiment of the present invention showing the static price the parker acknowledges and accepts before entering the parking facility.

### DESCRIPTION OF THE PREFERRED EMBODIMENTS

The present invention is directed to improved methods and systems for, among other things, demand-based pricing for parking facilities. The configuration and use of the presently preferred embodiments are discussed in detail below. It should be appreciated, however, that the present invention provides many applicable inventive concepts that can be embodied in a wide variety of contexts other than those specifically described herein. Accordingly, the specific embodiments discussed are merely illustrative of specific ways to make and use the invention, and do not limit the scope of the invention. In addition, the following terms shall have the associated meaning when used herein:

“application” is a software program designed to run on a mobile device;

“mobile device” means any portable computing device, typically having a display screen with touch input and/or a miniature keyboard, and includes, without limitation, the head unit; and

“parking facility” means an indoor or outdoor area for parking vehicles, including, for example, a parking garage, parking lot, parking ramp, car park and the like.

A parking system is presented in which the rates for parking vary based on variables determined by the parking facility operator. In one embodiment, the variable may be facility occupancy, in which case the system may be configured to increase prices when the facility reaches a certain capacity. In this instance, an event at a venue proximal to the parking facility operator's facility may cause high demand for parking in the surrounding area. The operator may pre-set the system of the present invention to increase the parking rate, either by a binary amount or incrementally, as the capacity of the facility increases.

In addition, the system may be configured to increase the parking fee based on a set dollar amount. For example, if the facility is at 20% occupancy, the parking rate may be $5 per hour, but at 30% occupancy, the rate increases to $6 per hour. Alternatively, the system may be configured to increase the parking fee on a percentage basis. For example, if the facility is at 20% occupancy, the parking rate may be $5 per hour but, and, as the occupancy rate exceeds 70%, the parking rate may increase by 30% and as the occupancy exceeds 90%, the rate increases by 100%.

In other embodiments of the present invention, the parking facility operator may elect to modify the parking rate based on vehicle size, model, weight, capacity, or other similar factors. Larger vehicles, such as oversized SUVs, may hold a high number of passengers. The system is equipped with one or more detectors configured to determine whether the vehicle entering the parking facility is compact or oversized, the occupancy capacity of the vehicle, and other measurable criteria relevant to the parking facility operator. Detectors may include, for example, license plate recognition cameras and vehicle type detection cameras and sensors.

In yet other embodiments of the present invention, the parking facility operator may elect to modify the parking rate based on ambient weather. Those skilled in the art can appreciate that inclement weather may cause covered parking spots to be in higher demand. The system is equipped with weather sensors or other data sources providing information to the system regarding the current and forecasted weather conditions. Parking prices may be adjusted, again either by a binary amount or incrementally, based on the weather conditions at the time the vehicle enters the parking facility.

In addition to the factors described above for adjusting parking fees, there are additional reasons the price of a parking price may be adjusted. For example, a parking facility operator may choose to adjust parking rates based on certain behavioral information, such as the frequency a parker uses the facility, the zip code in which the vehicle is registered, the type of vehicle, or the type of credit card being used to pay for the parking space.

In still other embodiments, the demand for parking spaces may be distributed on an auction basis so that those drivers or vehicles bidding the highest amount for a space would be awarded the space preferentially. For example, an autonomous vehicle that can drive itself from a starting point to a predefined destination in “autopilot” mode using various in-vehicle technologies and sensors, including a communication interface that allows Internet and inter-vehicle communications, may be searching for a parking space after dropping off a passenger. The parking facility could broadcast the availability of a parking space through a wireless network to the head units of automobiles in the area. When the broadcast is received, the head unit is configured to bid on the parking space within certain price and distance parameters. If the head unit broadcasts the winning bid, the parking facility notifies the vehicle and opens the gate to the facility when the vehicle arrives.

Alternatively, the availability of a parking space could be broadcast to the mobile device of a driver in search of a parking space and the driver could bid on the space through the driver's mobile device. Once again, if the driver is the successful bidder, the parking facility notifies the driver accordingly and opens the gate to the facility when the vehicle arrives.

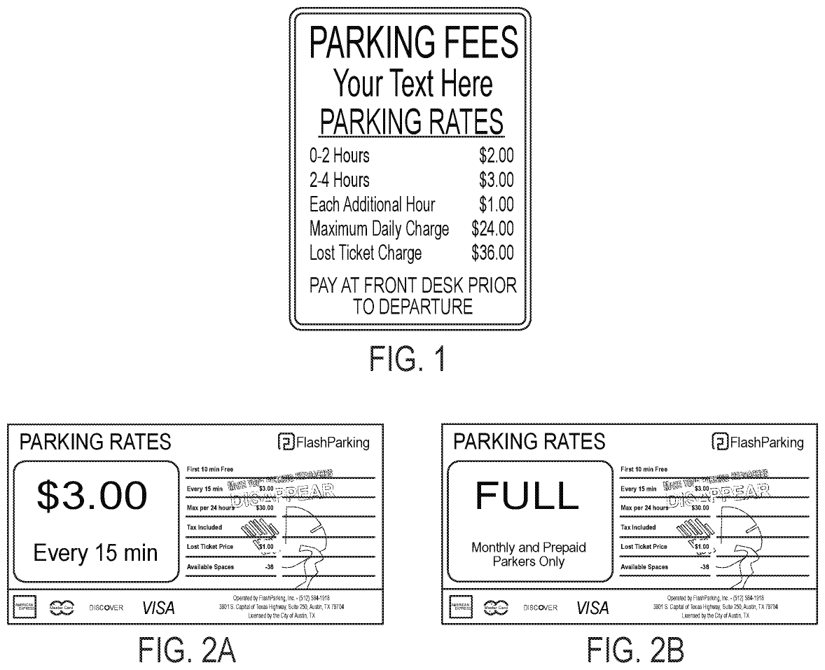

FIG. 1 shows a standard physical sign for a parking facility known in the art which is not dynamic and is costly to replace each time the rates changes.

Referring now to FIG. 2A which shows a digital display located at a parking facility utilizing an embodiment of the present invention. In this instance, the information—including the “First 10 minutes” rate, “Every 15 minutes” rate, the “Max per 24 Hour” rate, the “Lost ticket” rate and the “Number of spaces available”—is displayed to an hourly parker. As discussed above, the information on the display may change based on the capacity time of day, each of which communicates the current parking price to parkers and is updated automatically as the price changes;

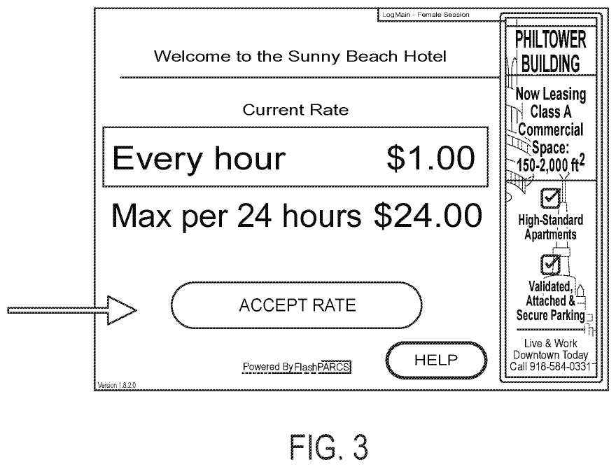

Referring now to FIG. 3 which shows a screenshot of a digital display at a parking facility utilizing one embodiment of the present invention. The display shows the static price the parker acknowledges and accepts by touching the “Accept Rate” button before entering the parking facility. Because the prices may fluctuate throughout a day, the driver may, for example, see a lower rate on the display when leaving the facility and believe that the rate he is paying is too high. Having the driver push the “Accept Rate” button increases the likelihood that the driver will remember the rate that he agreed to pay when entering the facility.

As briefly described above, as the system continues to gather data, it will analyze that data to understand trends and other factors relevant to past events. The analysis of that information will allow the system to understand patterns within a given set of events (occupancy, weather, local events, etc.) based on the transactional information received by the facility. This artificial intelligence functionality will continue to provide additional value as the amount of information gathered by the system grows.

Embodiments of the parking system of the present invention may include various hardware and software devices used to collect information about the parked vehicle. Information collected may include proximity information, motion information, barcodes, vehicle color, vehicle profile, vehicle weight and license plate number. By way of example, the system may include a proximity sensor, motion detector and/or a camera for capturing images of the vehicle's license plate. A proximity sensor or motion detector may be implemented by hardware, or they may be implemented by software.

While the present system has been disclosed according to the preferred embodiment of the invention, those of ordinary skill in the art will understand that other embodiments have also been enabled. Although specific advantages have been enumerated above, various embodiments may include some, none, or all of the enumerated advantages. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of parking systems known in the art, the detailed embodiments are intended to be illustrative only and should not be taken as limiting the scope of the invention. Rather, what is claimed as the invention is all such modifications as may come within the spirit and scope of the claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

To aid the Patent Office and any readers of any patent issued on this application in interpreting the claims appended thereto, the applicant wishes to note that it does not intend any of the appended claims or claim elements to invoke 35 U.S.C. 112(f) unless the words “means for” or “step for” are explicitly used in the particular claim.

We claim:

1. A system for dynamically setting prices of parking spaces, comprising:
a parking facility having plurality of parking spaces;
a vehicle detection system proximal to the parking facility;
a display for conveying information to a driver of the vehicle;
a computer processor configured to modify the price of a parking space based on predefined criteria;
wherein, when the vehicle is detected through the vehicle detection system, the computer processor determines the price to be charged for parking in one of the plurality of parking spaces and displays the price on the display.

2. The system for dynamically setting prices of parking spaces of claim 1, wherein the predefined criteria is weather conditions when the vehicle is detected through the vehicle detection system.

3. The system for dynamically setting prices of parking spaces of claim 1, wherein the predefined criteria is whether the vehicle's owner has signed a parking agreement with the parking facility.

4. The system for dynamically setting prices of parking spaces of claim 1, wherein the predefined criteria is a formula in which prices fluctuate based on occupancy of the parking facility.

5. The system for dynamically setting prices of parking spaces of claim 1, wherein the predefined criteria is the presence of events at nearby facilities.

6. The system for dynamically setting prices of parking spaces of claim 1, wherein the predefined criteria is a formula in which prices fluctuate based on the vehicle's size detected through the vehicle detection system.

7. The system for dynamically setting prices of parking spaces of claim 1, wherein the predefined criteria is a formula in which prices fluctuate based on vehicle type detected through the vehicle detection system.

8. The system for dynamically setting prices of parking spaces of claim 1, wherein the predefined criteria is a formula in which prices fluctuate based on behavioral data of the driver.

9. The system for dynamically setting prices of parking spaces of claim 1, wherein the predefined criteria is a zip code in which the vehicle is registered.

10. The system for dynamically setting prices of parking spaces of claim 1, wherein the predefined criteria is a type of credit card used to pay the price.

11. The system for dynamically setting prices of parking spaces of claim 1, wherein the parking facility is a parking garage.

12. The system for dynamically setting prices of parking spaces of claim 1, wherein the vehicle detection system is a license plate recognition camera.

13. The system for dynamically setting prices of parking spaces of claim 1, wherein the vehicle detection system is a proximity sensor.

14. The system for dynamically setting prices of parking spaces of claim 1, wherein the display is interactive and after the price is displayed to the driver, the driver accepts the price by touching the display.

15. A system for determining prices of parking spaces, comprising:
a parking facility having plurality of parking spaces;
a vehicle detection system proximal to the parking facility;
a computer processor configured to broadcast availability of one of the plurality of parking spaces over a network and the price for a parking space is determined by auction;
a display for displaying a winning bid to a driver of a vehicle;
wherein, when the vehicle having the winning bid is detected through the vehicle detection system, an access control system allows the vehicle to access the parking facility.

16. The system for determining prices of parking spaces of claim 15, wherein the parking facility is a parking garage.

17. The system for determining prices of parking spaces of claim 15, wherein the vehicle detection system is a license plate recognition camera.

18. The system for determining prices of parking spaces of claim 15, wherein the vehicle detection system is a proximity sensor.
